(19) United States
(12) Patent Application Publication
(10) Pub. No.: US 2012/0144617 A1
(43) Pub. Date: Jun. 14, 2012

(54) WIPER COVER

(75) Inventor: Godelieve Kraemer, Huegelsheim (DE)

(73) Assignee: ROBERT BOSCH GMBH, Stuttgart (DE)

(21) Appl. No.: 13/323,325

(22) Filed: Dec. 12, 2011

(30) Foreign Application Priority Data
Dec. 14, 2010 (DE) 10 2010 062 992.8

(51) Int. Cl. B60S 1/40; B60S 1/44; B60S 1/42

(52) U.S. Cl. 15/250.201; 15/250.32

(57) ABSTRACT

A wiper cover for a jointless wiper blade on a wiper arm of a wiper system comprises a fastening device for engaging with one end of the wiper arm, and a longitudinal groove for receiving a portion of the jointless wiper blade.

### BACKGROUND OF THE INVENTION

The invention relates to a wiper cover for a windshield of a motor vehicle. The invention relates in particular to a wiper cover for a jointless wiper blade, for mounting on a wiper arm of a wiper system of the motor vehicle. The invention also relates to a wiping device having a wiper cover and a jointless wiper blade.

A wiper system on a motor vehicle comprises a drive unit, which pivots a wiper arm about a wiper shaft in an oscillating manner, and a wiper blade, which is fastened to the wiper arm, for sweeping over a windshield of the motor vehicle. The wiper blade may be a so-called jointless wiper blade which conventionally comprises a strip-shaped spring element composed of steel, and a wiper lip which extends in the region of the spring element. The spring element may be preloaded in a concave shape in order to press ends of the wiper lip against the windshield. The jointless wiper blade is conventionally fastened centrally in a region between opposite ends of the wiper blade.

DE 103 40 140 A1 presents a jointless wiper blade of said type on a wiper system for a motor vehicle.

In particular if the wiper blade is very long, imperfections may arise in the guidance of the wiper blade over the windshield if the wiper blade is not adequately guided by the wiper arm. This can result in juddering, rattling or squeaking effects which adversely affect a wiping action and can acoustically be perceived as unpleasant.

To improve the guidance, a lower end, which faces toward the wiper shaft, of the wiper blade may be fastened to the wiper arm. The guidance of the opposite end of the wiper blade is however not significantly improved in this way.

### SUMMARY OF THE INVENTION

The invention is therefore based on the object of specifying a wiper system having a jointless wiper blade and improved guidance of the wiper blade.

A wiper cover according to the invention for a jointless wiper blade on a wiper arm of a wiper system comprises a fastening device for engaging with one end of the wiper arm, and a longitudinal groove for receiving a portion of the jointless wiper blade.

In this way, the fastening of the jointless wiper blade to the wiper arm can advantageously be realized by means of the wiper cover. The wiper blade accordingly need not comprise any wiper-specific suspension elements, such that the wiper blade can be used universally for different wiper systems. Furthermore, mounting and exchange of the wiper blade can be facilitated as a result of the reception of the wiper blade in the longitudinal groove. Furthermore, a contact pressure exerted by the wiper arm can be transmitted to the wiper blade uniformly by the wiper cover, while the wiper blade can at the same time be guided with respect to the wiper arm by the wiper cover. In this way, noise during wiping as a result of juddering of the wiper blade on a windshield can be prevented, and wear of the wiper blade can be reduced. Furthermore, the wiper cover may be designed so as to blend into the overall appearance of the motor vehicle, and if appropriate additionally be of aerodynamic shape.

The wiper cover preferably extends from the fastening device to an end of the wiper blade remote from the wiper shaft. A portion of the wiper blade between the fastening device and an end of the wiper blade facing the wiper shaft may be concealed in the region of the wiper arm. In this way, it is possible to obtain a visually and aerodynamically advantageous line layout, while at the same time ensuring that the supporting action of the wiper cover in the outer region of the wiper blade is realized. The inner region of the wiper blade may for example additionally be supported on the wiper arm.

The wiper cover has an underside, which faces toward the wiper arm, and a top side, which faces away from the wiper blade. In a preferred embodiment, a multiplicity of transverse grooves runs through the wiper cover from the underside in the direction of the top side, such that the wiper cover is flexible in a plane running along the longitudinal groove through the top side and the underside. Said plane encloses an angle of between 0° and 90° with the windshield. The transverse grooves preferably run parallel to one another, such that the wiper cover is divided, in the region of its underside, into individual portions or members which are connected to one another by a common spine in the region of the top side of the wiper cover.

The flexibility of the wiper cover in the described plane is advantageous because, in this way, the wiper cover together with the wiper blade can adapt to a convex surface of the windshield. The convex curvature of the windshield at the wiper blade varies as the wiper blade sweeps over the windshield, and the transverse grooves can serve to ensure a good adaptation of the wiper cover, and therefore of the wiper blade, to said curvature during a wiping process. Here, it is possible for a torsional strength of the wiper cover in a direction along the longitudinal groove and/or a bending stiffness in a direction running parallel to the windshield to be influenced only a little, or not at all, by the transverse grooves.

Portions of the wiper cover between adjacent transverse grooves may comprise retaining elements which are situated on opposite sides of the longitudinal groove from one another and which engage behind a portion of the wiper blade. Secure fixing of the wiper blade to the wiper cover can be obtained in this way.

In an alternative embodiment, the portions have in each case only one retaining element which is situated in each case on one side of the longitudinal groove, wherein the retaining elements of adjacent portions are attached to different sides of the longitudinal groove. In this way, the described flexibility of the wiper cover can be further improved with only an insignificant reduction in the retention action of the wiper blade in the direction of the windshield.

The wiper cover is preferably produced from a hard material, for example a plastic. A wind deflector (spoiler) composed of a soft material, for example rubber or a soft plastic, may be arranged on the top side of the wiper cover. The wind deflector can thereby be designed to be sufficiently flexible to follow the curvature of the windshield, wherein the described supporting action of the wiper cover can remain substantially uninfluenced by the wind deflector.

In a preferred embodiment, the wiper cover is connected to a further cover which extends from the fastening device in the direction of the wiper shaft, wherein a contour of the further cover merges into a contour of the wiper cover. In this way, an outer surface of the wiper system from a region of the drive shaft to an end of the wiper blade remote from the drive shaft can be designed as a whole so as to perform aerodynamic functions and to optimally utilize available installation space.

A wiping device comprises the wiper cover and a jointless wiper blade which is mounted on the wiper cover, wherein the wiper cover is designed for fastening to the end of a wiper arm of a wiper system. As a result, a separately handlable unit for wiping a windshield is formed which can be tailored for example as a function of the windshield, while further parts of the wiper system can remain non-specific. Production and marketing costs can be saved by means of this modular principle.

### BRIEF DESCRIPTION OF THE DRAWINGS

The invention will now be described in more detail with reference to the appended figures, in which:

FIG. 1 shows a wiper system;

FIG. 2 shows a wiper cover for the wiper system from FIG. 1;

FIG. 3 shows a cross section through the wiper system from FIG. 1 in the region of the wiper blade;

FIG. 4 shows a detail of the wiper cover from FIG. 2; and

FIG. 5 shows a wiper cover on the wiper system of FIG. 1 with a further cover.

### DETAILED DESCRIPTION

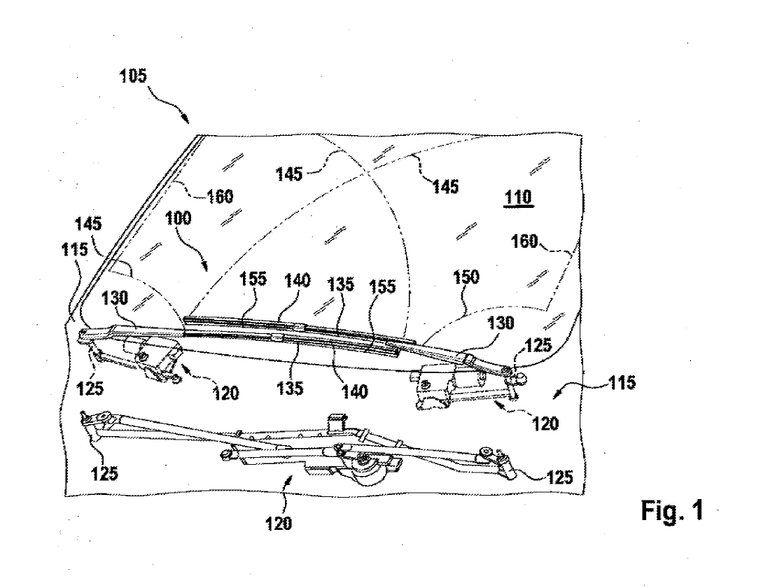

FIG. 1 shows a wiper system 100 on a motor vehicle 105. The motor vehicle 105 comprises a windshield 110 and a body 115.

The wiper system 100 comprises a drive device 120 having a wiper shaft 125, a wiper arm 130, a jointless wiper blade 135 and a wiper cover 140.

In the embodiment illustrated, said elements are provided in each case twofold and are designed and mounted on the body 115 of the motor vehicle 105 so as to form a wiper system 100 with two jointless wiper blades 135 running in opposite directions. In another embodiment, a codirectionally running wiper system 100 or a wiper system 100 with only one wiper arm 130 and a jointless wiper blade 135 may be used for the invention.

Illustrated in a lower region of FIG. 1 is a further drive device 120 which may be used as an alternative to the other two drive devices 120. The lower drive device 120 uses a single drive motor, the movement of which is transmitted by means of a linkage to two wiper shafts 125.

Ends of the wiper arms 130 are fastened in each case approximately to the center of the associated jointless wiper blade 135. The wiper covers 140 extend from the fastening point in each case outward in the direction of an outer circle 145 swept through by an outer end of the respective jointless wiper blade 135 during operation of the wiper system 100. An opposite end of the jointless wiper blade 135 sweeps in each case along an inner circle 155. In the illustration of FIG. 1, the two jointless wiper blades 135 are situated at a bottom reversal position 155 and, during operation of the wiper system 100, sweep over the windshield 110 in each case as far as a top reversal position 160.

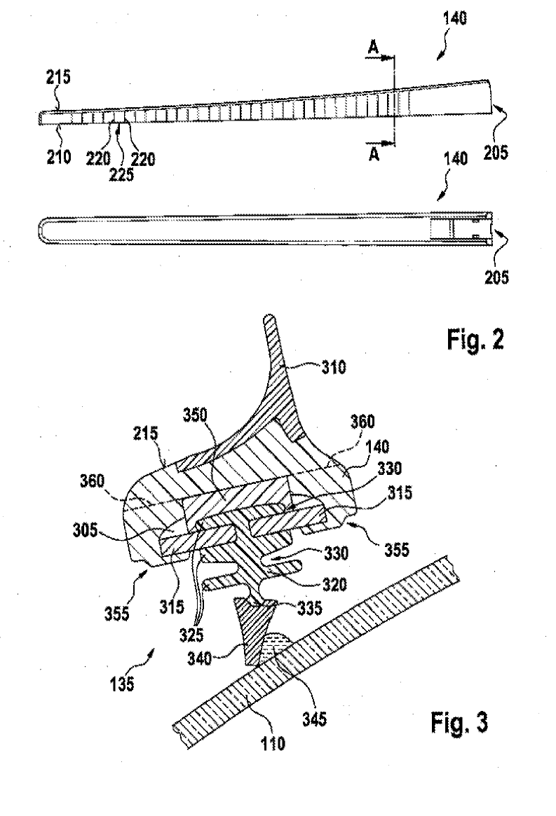

FIG. 2 shows a further embodiment of the wiper cover 140 for the wiper system 100 from FIG. 1. A side view is illustrated in the upper region of FIG. 2, and a plan view of the wiper cover 140 is illustrated in the lower region.

Situated at the right-hand end of the wiper cover 140 is a fastening device 205, also referred to as a retaining spring. The fastening device 205 is formed by a cutout in the wiper cover 140 for receiving an end of the wiper arm 130. The wiper arm 130 is secured in a known way by detent elements formed in the region of the fastening device 205.

A height and a width of the wiper cover 140 gradually decrease to the left proceeding from the fastening device 205. Here, the decrease in height, as illustrated in the upper region of FIG. 2, substantially corresponds to an exponential function, whereas the decrease in width, illustrated in the lower region of FIG. 2, substantially follows a linear function. More or less extreme decreases in width and/or height of the wiper cover 140 are also possible in other embodiments.

A number of transverse grooves 220 run in the wiper cover 140 proceeding from an underside 210 of the wiper cover 140 in the direction of a top side 215 of the wiper cover 140. The transverse grooves 220 run parallel to one another, and perpendicular to the direction of extent of the wiper cover 140, between the region of the fastening device 205 and the left-hand end of the fastening device 140, wherein in each case one portion 225 of the wiper cover 140 is situated between two adjacent transverse grooves 220. Depths of the transverse grooves 220 decrease from right to left corresponding to the height of the fastening device 140. No transverse grooves 220 are situated in the region of the fastening device 205 and in the region of the left-hand end of the wiper cover 140.

FIG. 3 shows a cross section through the wiper system 100 in the region of the wiper blade 135 from FIG. 1. The illustrated cross section corresponds to the section A-A through the wiper cover 140 from FIG. 2, wherein the wiper cover 140 illustrated in FIG. 3 is illustrated in another embodiment together with further elements in FIG. 3.

The illustrated wiper cover 140 has a longitudinal groove 305 which extends along its direction of extent, in FIG. 2 between the region of the fastening device 205 and the left-hand end. A portion of the jointless wiper blade 135 is received with a force fit in the longitudinal groove 305. A lower end of the jointless wiper blade 135 sweeps over the windshield 110. A wind deflector 310 is formed on the top side 215 of the wiper cover 140.

The jointless wiper blade 135 preferably comprises two steel strips 315 which are situated opposite one another and between which is arranged a first plastic element 320. The first plastic element 320 is composed preferably of a soft plastic and has three horizontal portions 325 which are situated one above the other and between which is situated in each case one constriction 330. The steel strips 315 are situated in the upper constriction 330. Below the lowermost horizontal portion 325, there is formed on the end of a narrow vertical web a projection 335 to which is attached a substantially wedge-shaped wiping lip 340. The wiping lip 340 is composed preferably of a different material than the first plastic element 320, preferably of a plastic which, in one embodiment, is harder than that of the plastic element 320. As a result of the narrow web between the projection 335 and the lowermost horizontal portion 325, the wiping lip 340 can pivot relative to the first plastic element 320. In the illustration of FIG. 3, the jointless wiper blade 135 is moving to the right relative to the windshield 110, and the wiping lip 340 is pivoted to the left. A water droplet 345 is located in a region between the windshield 110 and the wiping lip 340 in order to illustrate the cleaning of the windshield 110.

A second plastic element 350 of the jointless wiper blade 135 is attached in a region of the uppermost horizontal portion 325. The second plastic element 350 adjoins the steel strips 315 and surrounds an upper part of the uppermost horizontal portion 325 of the first plastic element 320. The second plastic element 350 is produced preferably from a plastic material harder than the first plastic element 320, and in a preferred embodiment, also harder than the wiping lip 340. The second plastic element 350 is in engagement, at its top side and in upper portions of its right-hand and left-hand vertical flanks, with the longitudinal groove 305 of the wiper cover 140. Retaining elements 355 are formed on the wiper cover 140 to the right and to the left of the longitudinal groove 305, which retaining elements surround the steel strips 315 in such a way that the jointless wiper blade 135 is retained in the direction of the windshield 110. For this purpose, the retaining elements 355 bear against outer edges and undersides of the steel strips 315.

The cross section through the wiper cover 140 illustrated in FIG. 3 runs through one of the portions 225 from FIG. 2. In the embodiment illustrated in FIG. 3, a retaining element 355 is provided both to the right and to the left of the longitudinal groove 305.

In an alternative embodiment, a retaining element 355 may be formed only on the right-hand side or only on the left-hand side of the longitudinal groove 305. On the other side, the portion of the retaining element 355 which otherwise bears against the underside of the corresponding steel strip 315 may be omitted. The wiper cover 140 may nevertheless be shaped so as to bear against an outer lateral boundary of the steel strip 315. In another embodiment, said region of the wiper cover 140 which bears laterally against the steel strip 315 may be omitted at one side, wherein a lateral area of contact against the second plastic element 350 may be attained, or in the region of the respective portion 225 the wiper cover 140 ends at one side at the dashed line 360, such that there is also no lateral area of contact against the second plastic element 350.

If, as described above, one of the retaining elements 355 is omitted in one of the portions 225 from FIG. 2, the opposite retaining element 355 is omitted in the adjacent portion 225, such that overall, each portion 225 has a retaining element 355 alternately at the right or at the left.

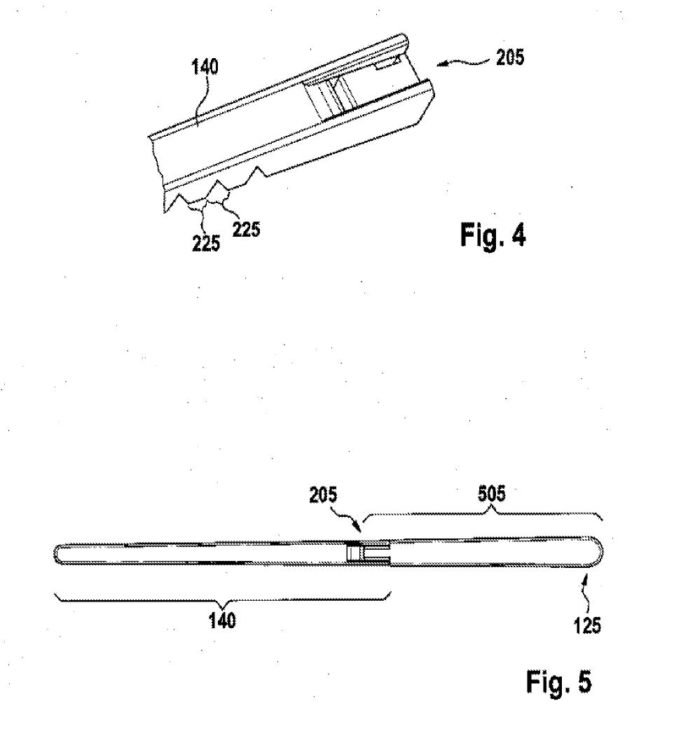

The wind deflector 310 in the upper region of the wiper cover 140 is optional. A transition between the wind deflector 310 and the top side 215 of the wiper cover 140 may be modeled in a suitable way, and does not necessarily follow the embodiment illustrated. If the wind deflector 310 is provided, it may advantageously be injection-molded onto the wiper cover 140 in a two-component injection molding process. If no wind deflector 310 is provided, the top side 215 of the wiper cover 140 is preferably rounded or flat, as shown for example in FIG. 4.

The jointless wiper blade 135 is mounted by the wiper cover 140 by virtue of an end of the jointless wiper blade 135 being threaded into the longitudinal groove 305 in the region of the fastening device 205 from FIG. 2 and then being pushed through to the left until the end of the wiper cover 140 is reached. The longitudinal groove ends preferably before the left-hand end of the wiper cover 140 in FIG. 2, such that the jointless wiper blade 135 can be pushed in as far as the end of the longitudinal groove 305. The wiper cover 140 is connected at the fastening device 205 to one end of the wiper arm 130 from FIG. 1. As a result of the described form of the wiper cover 140, fixing of the jointless wiper blade 135 is realized along the wiper cover 140, such that a flexibility of the wiper blade in a plane perpendicular to the steel strips 315 is maintained, such that the wiping lip 340 is pressed over its entire length against the windshield 110, while at the same time a flexibility of the jointless wiper blade 135 in a plane spanned by the steel strips 315 is reduced.

FIG. 4 shows a detail of the wiper cover 140 from FIG. 2. It is possible to see how the cutout which forms the fastening device 205 is formed at the left-hand end of the wiper cover 140. In the illustrated embodiment of the wiper cover 140, each portion 225 comprises only one retaining element 355, such that adjacent portions 225 are designed to hold the jointless wiper blade 135 on opposite sides.

FIG. 5 shows a wiper cover 140 on the wiper system 100 of FIG. 1 with a further cover 505. In the plan view shown, it can be seen that the further cover 505 covers the wiper arm 130 from the region of the fastening device 205 to the right as far as a region of the wiper shaft 125. Here, the contours of the wiper cover 140 and of the further cover 505 are in particular designed in the region of the fastening device 205 so as to merge into one another.

1. A wiper cover (140) for a jointless wiper blade (135) on a wiper arm (130) of a wiper system (100), characterized by
a fastening device (205) for engaging with one end of the wiper arm (130); and
a longitudinal groove (305) for receiving a portion of the jointless wiper blade (135).

2. The wiper cover (140) according to claim 1, wherein the wiper arm (130) is mounted so as to be rotatable about a wiper shaft and the wiper cover (140) extends from the fastening device (205) to an end of the wiper blade (135) remote from the wiper shaft (125).

3. The wiper cover (140) according to claim 1, characterized in that a multiplicity of transverse grooves (220) runs from an underside (210), which faces toward the wiper blade (135), in the direction of a top side (215), which faces away from the wiper blade (135), of the wiper cover (140), such that the wiper cover (140) is flexible in a plane running through the underside (215) and the top side (210).

4. The wiper cover (140) according to claim 3, characterized in that portions (225) of the wiper cover (140) between adjacent transverse grooves (220) comprise retaining elements (355) which are situated on opposite sides of the longitudinal groove (305) from one another and which engage behind a portion of the wiper blade (135).

5. The wiper cover (140) according to claim 3, characterized in that portions (225) between adjacent transverse grooves (220) comprise in each case one retaining element (355) which is situated on one side of the longitudinal groove (305) and which engages behind a portion of the wiper blade (135), wherein the retaining elements (355) of adjacent portions (225) are attached to different sides of the longitudinal groove (305).

6. The wiper cover (140) according to claim 1, characterized in that the wiper cover (140) is produced from a hard material, and a wind deflector (310) composed of a soft material is formed on the top side (215), which faces away from the wiper blade (135), of the wiper cover (140).

7. The wiper cover (140) according to claim 2, characterized in that it is connected to a further cover (505) which extends from the fastening device (205) in the direction of the wiper shaft (125), wherein a contour of the further cover (505) merges into a contour of the wiper cover (140).

8. A wiping device (135, 140) comprising the wiper cover (140) according to claim 1, wherein a jointless wiper blade (135) is mounted on the wiper cover (140) and the wiper cover (140) is designed for fastening to the end of a wiper arm (130) of a wiper system (100).

9. A wiper apparatus comprising:
a jointless wiper blade (135) configured to be mounted on a wiper arm; and
a wiper cover (140) including a fastening device (205) configured to engage with one end of the wiper arm (130), and a longitudinal groove (305) for receiving a portion of the jointless wiper blade (135).

10. A wiper apparatus according to claim 9, wherein the wiper arm (130) is mounted so as to be rotatable about a wiper shaft and the wiper cover (140) extends from the fastening device (205) to an end of the wiper blade (135) remote from the wiper shaft (125).

11. A wiper apparatus according to claim 9, wherein the wiper cover includes a multiplicity of transverse grooves (220) that run from an underside (210), which faces toward the wiper blade (135), in the direction of a top side (215), which faces away from the wiper blade (135), of the wiper cover (140), such that the wiper cover (140) is flexible in a plane running through the underside (215) and the top side (210).

12. A wiper apparatus according to claim 11, wherein portions (225) of the wiper cover (140) between adjacent transverse grooves (220) comprise retaining elements (355) which are situated on opposite sides of the longitudinal groove (305) from one another and which engage behind a portion of the wiper blade (135).

13. A wiper apparatus according to claim 11, wherein portions (225) between adjacent transverse grooves (220) comprise in each case one retaining element (355) which is situated on one side of the longitudinal groove (305) and which engages behind a portion of the wiper blade (135), wherein the retaining elements (355) of adjacent portions (225) are attached to different sides of the longitudinal groove (305).

14. A wiper apparatus according to claim 9, wherein the wiper cover (140) is produced from a hard material, and a wind deflector (310) composed of a soft material is formed on a top side (215), which faces away from the wiper blade (135), of the wiper cover (140).

15. A wiper apparatus according to claim 10, wherein the wiper cover is connected to a further cover (505) which extends from the fastening device (205) in the direction of the wiper shaft (125), wherein a contour of the further cover (505) merges into a contour of the wiper cover (140).
